(19) United States
(12) Patent Application Publication
(10) Pub. No.: US 2025/0313508 A1
(43) Pub. Date: Oct. 9, 2025

(54) CALCINATION APPARATUS AND PROCESSES WITH IMPROVED CO2 CAPTURE

(71) Applicant: THE UNIVERSITY OF ADELAIDE, Adelaide (AU)

(72) Inventors: Mehdi JAFARIAN, Adelaide (AU); Bassam DALLY, Thuwal (SA); Graham Jerold NATHAN, Adelaide (AU)

(21) Appl. No.: 18/865,149

(22) PCT Filed: May 12, 2023
(86) PCT No.: PCT/AU2023/050409

§ 371 Date: Nov. 12, 2024

(30) Foreign Application Priority Data
May 12, 2022 (AU) 2022901270

(51) Int. Cl. C04B 2/10; B01D 53/62; C01B 15/013; C04B 7/36; C04B 7/44; F27B 15/14; F27D 13/00; F27D 17/10

(52) U.S. Cl. CPC C04B 2/108; B01D 53/62; C01B 15/013; C04B 7/367; C04B 7/4407; F27B 15/14; F27D 13/00; F27D 17/10; B01D 2257/504; B01D 2258/0233

(57) ABSTRACT

A calcination and cement production apparatus comprising a calciner configured to be heated by combustion of a carbon based fuel and a hydrogen peroxide oxidant composition is disclosed.

### PRIORITY DOCUMENT

The present application claims priority from Australian Provisional Patent Application No. 2022901270 titled “CALCINATION APPARATUS AND PROCESSES WITH IMPROVED CO₂ CAPTURE” and filed on 12 May 2022, the content of which is hereby incorporated by reference in its entirety.

### TECHNICAL FIELD

The present disclosure relates to calcination processes.

### BACKGROUND

The production of cement and lime produces 7% of the global anthropogenic CO₂ emissions, with 0.7-1.1 ton of CO₂ emitted per ton of cement or lime product produced (Schneider et al. 2011). Of these emissions, one third originates from the combustion of fuels, while approximately two thirds are process related, originating mainly from the calcination of limestone, CaCO₃, as follows:

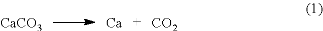

This reaction is highly endothermic with an enthalpy of ˜178 KJ/mol CaCO₃ which means it requires an external heat source, such as heat provided by combustion of CO₂ generating fossil fuels. The replacement of fossil fuels with any alternative energy source, such as alternative fuels or renewable energy, can only mitigate approximately one-third of the CO₂ emissions. For this reason, CO₂ capture, for storage or re-use, is widely regarded as being an essential element in the mitigation of CO₂ emissions from cement and lime production. Nevertheless, despite the urgent need for and the technical feasibility of the CO₂ capture from cement and lime production, it is not yet economically viable in current markets.

Several CO₂ capture technologies are currently being developed, which are classified as pre-combustion, post-combustion or oxy-fuel combustion. However, most of them have the consequence of high energy consumption, leading to lower process efficiency and increased costs.

Pre-combustion capture recovers CO₂ before the fuel is burned. This process involves converting from a hydrocarbon fuel to a carbon-free fuel, such as hydrogen, most commonly by steam-methane reforming to generate (after several steps) a mixture of H₂ and CO₂. The CO₂ is then separated to generate industrially pure H₂, which is carbon free. Pre-combustion capture, despite its relevance, is not sufficient for cement and lime production processes because it only addresses the fuel-derived CO₂ emissions, while the greater proportion of CO₂ emissions are derived from the calcination of the CaCO₃.

Post-combustion capture methods absorb CO₂ from the flue gas, typically through a commercially available amine scrubbing process using monoethanloamine (MEA) as the solvent, making it applicable to the capture of both combustion and process-related emissions. Advantageously, post-combustion capture can be retrofitted to existing cement and lime production processes without the need for major modification. However, post combustion capture based on the MEA process is very energy intensive, requiring considerable amount of heat for solvent regeneration (˜3.5 GJ/t CO₂) (Mota-Martinez, Hallett, and Mac Dowell 2017) which adds significantly to the costs. Moreover, the flue gas from a kiln contains a number of contaminants, such as NOx and SOx, which can deactivate MEA by producing heat stable salts (Bosoaga, Masek, and Oakey 2009).

In oxy-fuel combustion capture, the combustion air is replaced with industrially pure oxygen. This avoids the dilution of CO₂ with N₂ from the air, but generates a need to manage the flame temperature, which would otherwise lead to an increase in the adiabatic flame temperature relative to that of air flames, owing to the elimination of the N₂ from the oxidant gas (Buhre et al. 2005). Therefore, oxy-fuel combustion systems typically recycle a fraction of the flue gas to the combustor to moderate the flame temperature (Figueroa et al. 2008). The CO₂ is separated from the flue gas via a condensation process, in which the flue gas is cooled to condense and separate the water. Furthermore, air is typically also used elsewhere in the process as the heat transfer media, both to cool the clinker and to pre-heat the raw-material (Boateng 2015). That is, the combustion air is typically heated by cooling the hot product, while the hot combustion products are used to preheat the raw material (Voldsund et al. 2019). Thus, the use of oxy-fuel combustion for CO₂ capture in cement and lime plants requires the process components to be modified to avoid energy losses. Firstly, the volumes and the composition of the gases flowing in an oxy-fuel system are different from those of conventional plants; and, secondly an alternative method is needed to recover the enthalpy from the hot clinker to pre-heat the raw-material. In addition, an air separation unit (ASU) is also typically needed to produce industrially pure oxygen, which adds to the costs and complexity of the process. Nevertheless, despite the required modifications of the process and the need for an ASU unit, oxy-fuel combustion has been identified as a technology with potential to achieve higher capture efficiency at a lower cost than alternative post combustion processes (Gerbelová, van der Spek, and Schakel 2017). Commensurate with this Voldsund et al. (Voldsund et al. 2019) have shown that oxy-fuel combustion capture has the lowest Specific Energy Consumption for CO₂ Avoided (SPECCA2) of 1.63 MJ/kg CO₂, of which a significant part is associated with the production of industrially pure oxygen. Cryogenic air separation is currently the most mature and reliable technology for large scale industrially pure O₂ production (Higginbotham et al. 2011). However, it is very energy intensive process. Furthermore, the cost of O₂ production increases with the purity of the O₂ which, in turn, influences the cost of CO₂ capture. This is because any slippage of N₂ has a significant effect on the cost and efficiency of the CO₂ capture.

There is a need for alternative approaches for CO₂ capture in calcination processes such as cement and lime production. Alternatively, or in addition, there is a need for improvements in CO₂ capture technologies in calcination processes such as cement and lime production.

### SUMMARY

According to a first aspect, there is provided a calcination apparatus comprising a calciner configured to be heated by combustion of a carbon-based fuel and a hydrogen peroxide oxidant.

According to a second aspect, there is provided an apparatus for lime (CaO) production, the apparatus comprising the calcination apparatus of the first aspect.

According to a third aspect, there is provided an apparatus for cement clinker production, the apparatus comprising the calcination apparatus of the first aspect and a kiln configured to be heated by combustion of a carbon-based or hydrogen-based fuel and a hydrogen peroxide oxidant.

According to a fourth aspect, there is provided a system for reducing carbon dioxide emission levels during the manufacture of lime or cement clinker, the system comprising the calcination apparatus of the first aspect.

In certain embodiments of any of the first, second, third or fourth aspects, the hydrogen peroxide oxidant can be an aqueous hydrogen peroxide solution or a gaseous mixture of hydrogen peroxide and water or pure hydrogen peroxide.

In certain other embodiments of any of the first, second, third or fourth aspects, the hydrogen peroxide oxidant is a gaseous mixture of hydrogen peroxide and water. In these embodiments, the calcination apparatus may further comprise a boiler unit for evaporating an aqueous hydrogen peroxide solution to produce a gaseous hydrogen peroxide oxidant. The boiler unit may evaporate and, optionally, concentrate the aqueous hydrogen peroxide solution by heating. The boiler unit may be heated by hot gases from the calciner, hot air recovered from the clinker cooler, electricity or any other high temperature heat sources.

In certain embodiments of any of the first, second, third or fourth aspects, the calcination apparatus further comprises a first heat exchanger configured to heat raw material to be fed to the calciner.

In certain embodiments of any of the first, second, third or fourth aspects comprising a first heat exchanger, the calcination apparatus further comprises a second heat exchanger configured to cool a product material exiting the calciner and transfer heat to the first heat exchanger.

According to a fifth aspect, there is provided a process for calcining a raw material to produce a calcined product, the process comprising:
introducing the raw material to a calcination apparatus; and
heating the raw material in the calcination apparatus using heat generated from combustion of a carbon-based fuel and a hydrogen peroxide oxidant under conditions to produce the calcined product.

In certain embodiments of the fifth aspect, the process comprises evaporating an aqueous hydrogen peroxide solution to produce a gaseous hydrogen peroxide oxidant. The aqueous hydrogen peroxide solution may be evaporated by heating. The aqueous hydrogen peroxide solution may be evaporated by heating using hot gases from the calcination apparatus, hot air recovered from the clinker cooler, electricity or any other high temperature heat sources.

In certain embodiments of the fifth aspect, the process comprises heating the raw material prior to introduction to the calcination apparatus.

In certain embodiments of the fifth aspect, the process comprises heating the raw material using heat from the calcined product.

### BRIEF DESCRIPTION OF THE FIGURES

Embodiments of the present disclosure will be discussed with reference to the accompanying figures wherein:

FIG. 1 is a schematic representation of an apparatus and process configuration for the use of an aqueous solution of hydrogen peroxide (HP) for lime production with CO₂ capture, referred to as hydrogen peroxide fuel oxidation (HPFOX_{C}). The heat recovered from the flue gas of the calciner is utilised to preheat and evaporate the inlet HP aqueous solution, while the heat recovered from the hot lime product is employed to preheat the raw material;

FIG. 2 is a schematic representation of another apparatus and process configuration for the use of an aqueous solution of hydrogen peroxide (HP) for lime production with CO₂ capture (HPFOX_{C}). Heat recovered from the hot gas leaving the calciner is used to preheat the raw material. Heat recovered from hot product is utilised to preheat and evaporate the inlet HP-water mixture;

FIG. 3 is a schematic representation of another apparatus and process configuration for the use of an aqueous solution of hydrogen peroxide (HP) for lime production with CO₂ capture (HPFOX_{C}). An aqueous HP mixture is directly introduced into the calciner and heat recovered from hot product is utilised to preheat the inlet raw material;

FIG. 4 is a schematic representation of an apparatus and process configuration for the use of an aqueous solution of hydrogen peroxide (HP) for fuel oxidation in a kiln and calciner (HPFOX_{C+K}) for cement production. The direct heat exchangers (HX) are used to vaporise and preheat the inlet aqueous HP solution and to preheat the inlet raw materials using heat recovered from the other process streams;

FIG. 5 is a schematic representation of another apparatus and process configuration for the use of an aqueous solution of hydrogen peroxide (HP) for fuel oxidation in a kiln and calciner (HPFOX_{C+K}) for cement production. Heat recovered from hot product is used to evaporate hydrogen peroxide. Heat recovered from flue gas leaving the calciner and kiln is utilised to preheat the raw material;

FIG. 6 is a schematic representation of another apparatus and process configuration for hydrogen peroxide fuel oxidation in calciner and kiln (HPFOX_{C+K}) for cement production. Aqueous hydrogen peroxide is directly introduced into both the calciner and the kiln. Heat recovered from hot product is used to preheat the inlet raw material. The high temperature stream leaving the calciner and the kiln can be used for power production or to supply process heat;

FIG. 7 is a schematic representation of an apparatus and process configuration for hydrogen peroxide fuel oxidation in calciner (HPFOX_{C}) for cement production. Heat recovered from the flue gas of the calciner is utilised to preheat and evaporate the inlet aqueous HP solution, while the heat recovered from the hot flue gas leaving the kiln together with the heat recovered from the hot product are employed to preheat the raw materials;

FIG. 8 is a schematic representation of another apparatus and process configuration for hydrogen peroxide fuel oxidation in calciner (HPFOX_{C}) for cement production. Heat recovered from the hot flue gas leaving the kiln is used to evaporate HP solution, heat recovered from hot product is used to preheat combustion air of the kiln and heat recovered from the hot flue gas leaving the calciner is used to preheat the raw material;

FIG. 9 is a schematic representation of another apparatus and process configuration for hydrogen peroxide fuel oxidation in calciner (HPFOX_{C}) for cement production. Heat recovered from the hot flue gas leaving the kiln is used to evaporate HP solution. Heat recovered from the hot product is used to preheat combustion air of the kiln and preheat HP solution and heat recovered from the hot flue gas leaving the calciner is used to preheat the raw material;

FIG. 10 shows calculated adiabatic flame temperature for combustion of CH₄ for various values of excess oxygen and as a function of (a) temperatures of the HP solution and various weight fractions of HP in water with hydrogen peroxide as the oxidant and (b) temperature of the air for the case of conventional combustion in air as a function of air pre-heat temperature. The minimum auto-ignition temperature of CH₄ in air is also shown;

FIG. 11 shows estimated regimes for the dew-point and bubbling-onset for HP and water both calculated and experiments (Hatanaka and Shibauchi 1989);

FIG. 12 shows calculated adiabatic flame temperature for the combustion of carbon (C) for various values of excess oxygen and as a function of (a) temperature of the HP solution and various weight fractions of HP in water with hydrogen peroxide as the oxidant and (b) temperature of the air with air as the oxidant as a function of air pre-heat temperature. The minimum auto-ignition temperature of C in air is also shown.

### DESCRIPTION OF EMBODIMENTS

Details of terms used herein are given below for the purpose of guiding those of ordinary skill in the art in the practice of the present disclosure. The terminology in this disclosure is understood to be useful for the purpose of providing a better description of particular embodiments and should not be considered limiting.

Unless otherwise explained, all technical and scientific terms used herein have the same meaning as commonly understood by one of ordinary skill in the art to which this disclosure belongs.

In the context of the present disclosure, the terms “about” and “approximately” are used in combination with an amount, number, or value, then that combination describes the recited amount, number, or value alone as well as the amount, number, or value plus or minus 20% of that amount, number, or value. By way of example, the phrases “about 40%” and “approximately 40%” disclose both “40%” and “from 32% to 48%, inclusive”.

The singular terms “a”, “an”, and “the” include plural referents unless context clearly indicates otherwise. The term “comprises” means “includes”. Therefore, comprising “A” or “B” refers to including A, including B, or including both A and B.

Although methods and materials similar or equivalent to those described herein can be used in the practice or testing of the present disclosure, suitable methods and materials are described herein. In case of conflict, the present specification, including explanations of terms, will control. In addition, the materials, methods, and examples are illustrative only and not intended to be limiting.

The present disclosure provides a calcination apparatus comprising a calciner configured to be heated by combustion of a carbon-based fuel and a hydrogen peroxide oxidant.

The calcination apparatus can be used in any suitable calcination process. As used herein, the term “calcination process”, and related terms, means any process that involves heating a solid material to cause chemical separation of its components. A well-known calcination process is the dissociation of calcium carbonate to produce calcium oxide and carbon dioxide (i.e. CaCO₃→CaO+CO₂) in the production of cement and lime from limestone, calcium carbonate, clay soils or other CaCO₃ containing or generating materials. However, it will also be appreciated that the technology described herein can also be applied in other calcination processes, including, but not limited to, the production of alumina from bauxite, production of magnesium oxide from magnesite, processing of diatomaceous earth, processing of kaolin clay, production of expanded clay aggregates, conversion of spodumene to lithium, catalyst preparation, and pigment production.

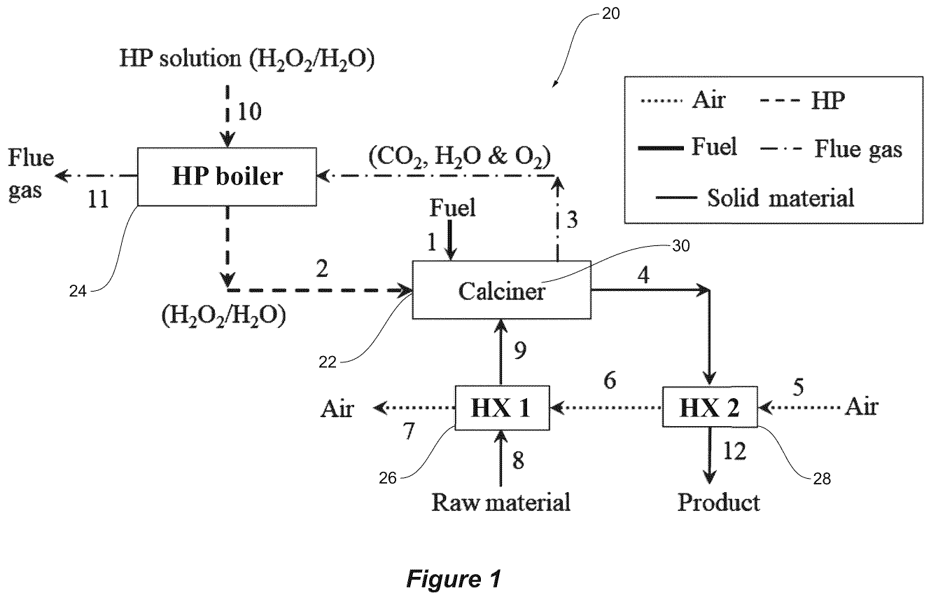

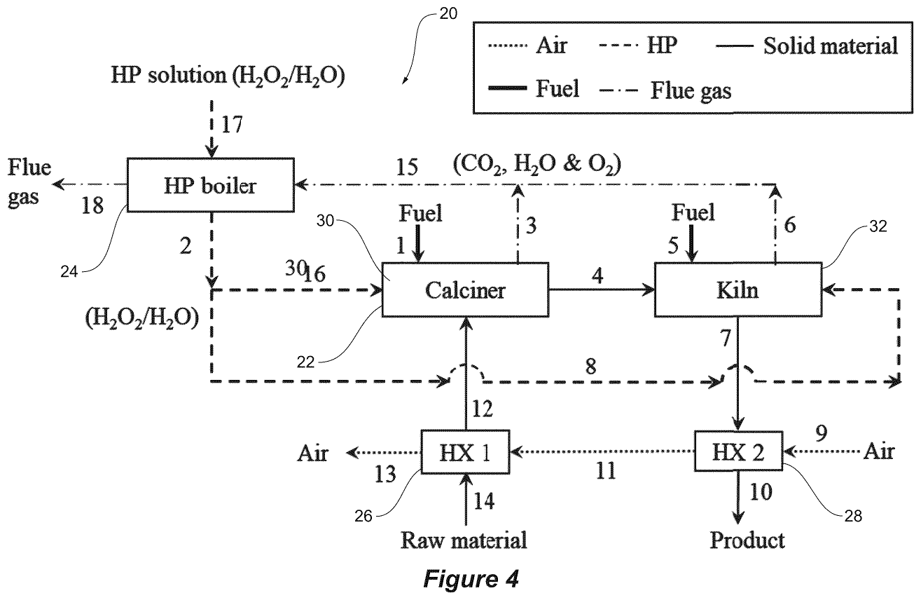

Embodiments of the calcination apparatus 20 of the present disclosure are shown in FIGS. 1 to 9, the details of which will be discussed further below. The calcination apparatus 20 shown in FIGS. 1, 2 and 3 is suitable for calcining calcium carbonate, clay soils or limestone (CaCO₃) to produce calcium oxide or lime (CaO). The calcination apparatus 20 shown in FIGS. 4 to 9 is suitable for producing cement clinker from limestone.

The calcination apparatus 20 comprises a calciner 22. The calciner 22 comprises a calcining chamber 30 in which the raw material is to be heated and calcined. The calciner 22 may be a rotary kiln, a grate kiln, a shaft kiln, a suspension reactor, a flash reactor or any directly or indirectly heated reactor configuration in which the calcination reaction is performed e.g., indirectly heated CALIX calcination reactor. Suitable reactors for all these processes are commercially available.

Heat is supplied to the calcining chamber 30 by combusting a carbon-based fuel and the hydrogen peroxide oxidant composition. Optionally, heat may also be supplied to the calcining chamber 30 by a second energy source. The second energy source can be provided from a wide range of energy sources including electrical heating (e.g., by thermal plasma, microwave, radiative or resistive heating), combustion of hydrogen or oxygen, high temperature particles, high temperature liquid, high temperature gas and heat transfer medium or concentrated solar thermal energy. The calcining chamber 30 may be heated directly and/or indirectly by radiation, convection or a combination of them.

Calcination occurs in the calcining chamber 30 at temperatures typically in the range of about 500° C. to about 1000° C. or higher, although it will be appreciated that lower or higher temperatures may also be needed based on the type of material to be calcined.

The apparatus 20 can be built de novo. However, the apparatus 20 can also advantageously be readily retrofitted to an existing calcination plant.

The carbon-based fuel used in the combustion may be any one of coal, biomass, bio-oils, refuse-derived fuels, synthesis gas (syngas) and natural gas or any fossil-fuel or renewable source fuels.

The oxidizer in the combustion process is derived from the hydrogen peroxide oxidant.

Hydrogen peroxide (H₂O₂ and hereafter also referred to as ‘HP’) has recently emerged as a potential route for CO₂ capture for applications in coal/biomass-fired boilers (Lin et al. 2019). It is an oxidant that decomposes exothermically at approximately 450° C., producing H₂O and O₂,

$$\begin{matrix}{H}_{2} {0}_{2} \to {H}_{2} 0 + {0.5}_{2} & {ΔH}_{dis} = - 98 \frac{kJ}{{mol}_{{H}_{2} {O}_{2}}}\end{matrix} . \qquad ( 2 )$$

It is liquid in ambient temperatures with a nominal boiling point of 150° C. (under a pressure of 1.0 atm). Hydrogen peroxide (HP) also has significant industrial application, with a global production of approximately 5.5 million tonnes per year (Ciriminna et al. 2016). Diluted HP in water at concentrations of 3-5 weight percent (wt. %) is used widely as an antimicrobial and oxidising agent for household, medical/dental and cosmetic applications. Similarly, it is used at higher concentrations of up to 70 wt. % in chemical synthesis, wastewater treatment, mining and for bleaching. At even higher concentrations of 70-90 wt. %, HP is used for cleaning and anti-corrosion purposes, while at 85-98 wt. % it is used for propulsion in rockets (Kuan, Chen, and Chao 2007; Okninski et al. 2021). In addition, HP is also utilised as a flame stabiliser to enhance the reaction rate and flame burning velocity through increasing the active intermediate radicals, e.g. OH, HO₂, HCO, CH₂O, CH₃O and O, in flame (Chen et al. 2011; Wang et al. 2019; Gardarsdottir et al. 2019; Han, Lee, and Bae 2015). More recently HP has also been identified as a potential environmentally benign renewable energy carrier that can be directly produced from renewable resources and used in fuel cells for electricity generation (Fukuzumi, Yamada, and Karlin 2012). This wide range of applications has justified significant effort to the development of future technologies for the efficient and direct production of HP from renewable energy resources e.g. through electrochemical synthesis of HP from oxygen reduction (Lu et al. 2018) and solar water oxidation (Liu et al. 2019).

In the lime production process, temperatures of up to approximately 850° C. are required to convert limestone into lime at appropriate reaction rates where the required heat is extracted through the combustion of hydrocarbon fuels in the freeboard gas and transferred to the bed by radiation, convection or a combination of them. The present inventors have calculated that the combustion of CH₄ and C with an aqueous solution of hydrogen peroxide with a mass fraction of >˜50 weight (wt.) % hydrogen peroxide can achieve temperatures of >1825° C., which is some 400° C. higher than the maximum 1450° C. temperature required for the clinkering reaction within cement kilns. Also combustion of CH₄ and C with a HP mixture with mass fractions of >˜40% can achieve a temperature of ˜1600° C., which is some ˜750° C. higher than the required calcination temperature of 850° C.

The hydrogen peroxide oxidant may be gaseous. A gaseous hydrogen peroxide oxidant is produced by evaporating an aqueous hydrogen peroxide solution in a boiler unit 24. The boiler unit 24 evaporates the aqueous hydrogen peroxide solution by heating using hot gases from the calciner 22 or from the kiln 32. The boiler unit 24 can take any suitable form such as, for example, a shell and tube heat exchanger. The hydrogen peroxide oxidant can be also pre-evaporated via electrical heating, or any other adequately high temperature heat source etc. A catalyst can optionally be used to dissociate the hydrogen peroxide mixture prior to it being introduced into the reactor. The catalyst can be in the form of a fixed bed, a fluidised bed, a combination of them, or any other appropriate configurations. The dissociation of hydrogen peroxide can be also facilitated using plasma, microwave, or any other external exciter. Alternatively, dissociation of the hydrogen peroxide can occur within the calciner or kiln.

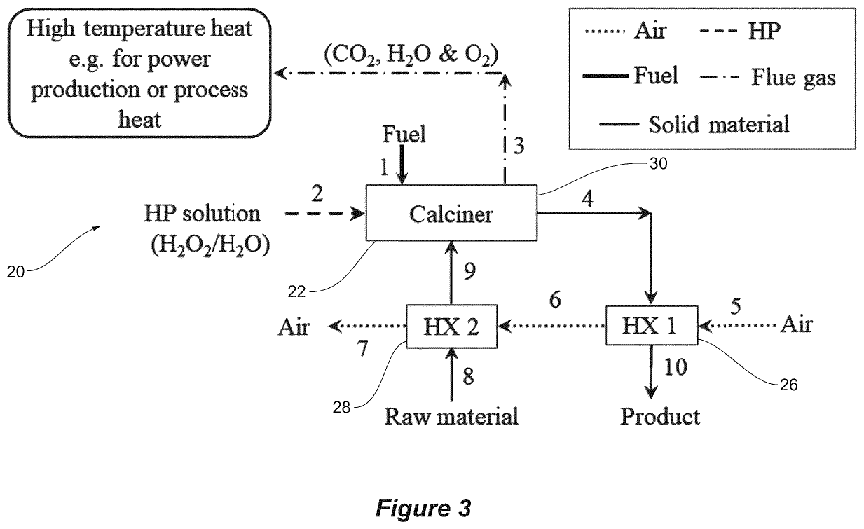

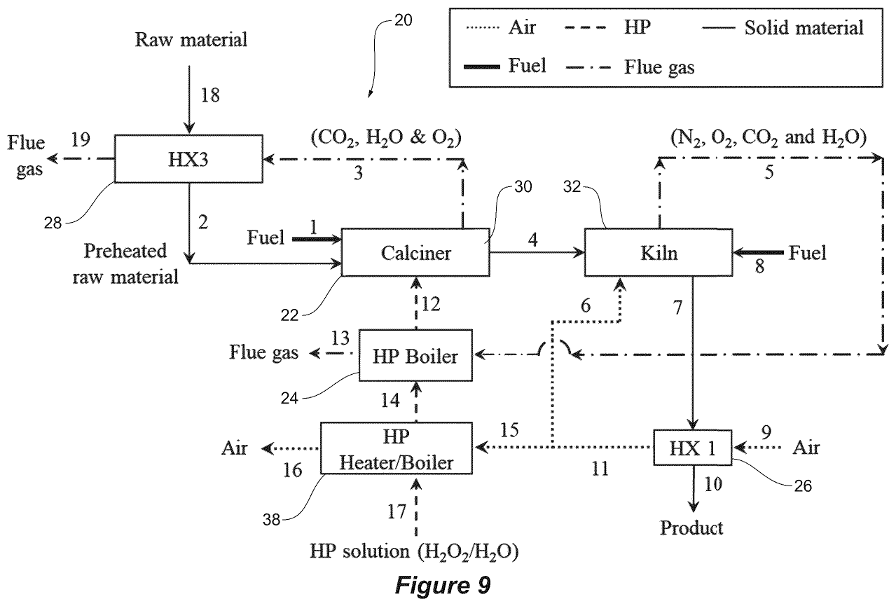

In an alternative embodiment shown in FIGS. 3 and 9, a hydrogen peroxide-water mixture is directly introduced into the calciner 22 and/or kiln 32, especially if it is at sufficiently high concentrations, enabling adequately high adiabatic flame temperatures and fast dissociation rate.

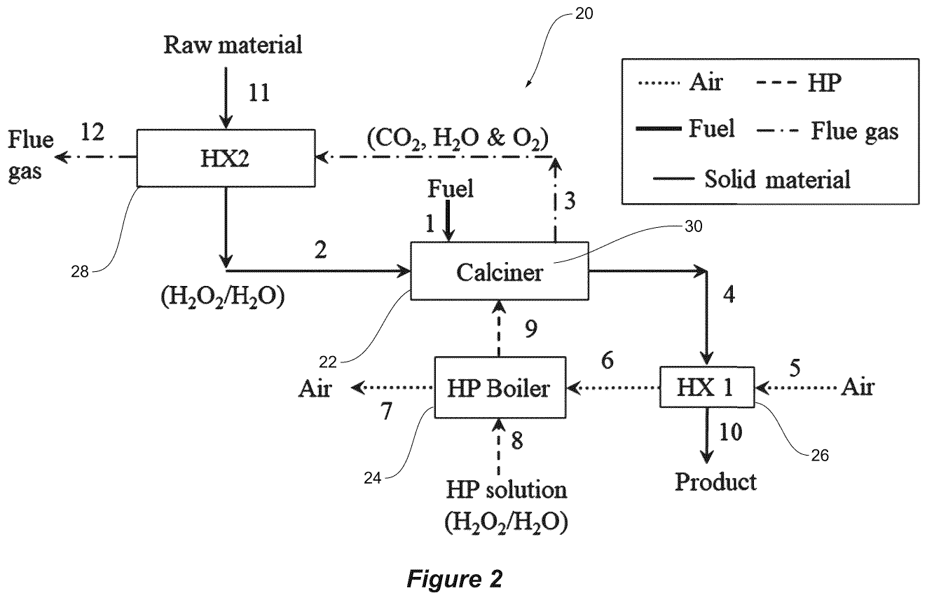

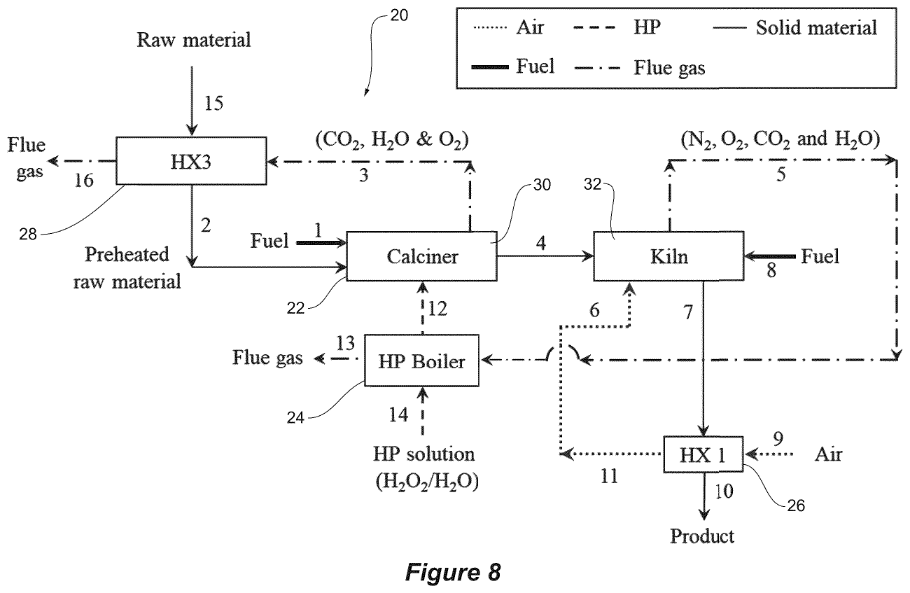

The calcination apparatus 20 shown in FIGS. 1 to 9 also comprises a first heat exchanger 26 and a second heat exchanger 28. In the embodiments shown in FIGS. 1, 4, and 7, the first heat exchanger 26 is configured to heat raw material to be fed to the calciner 22. In the embodiments shown in FIGS. 2, 5 and 9, the first heat exchanger 26 is configured to supply heat to the boiler unit 24 or the heater/boiler 38. In the embodiment shown in FIG. 8, the first heat exchanger 26 is configured to supply heat to the kiln 32.

In the embodiments shown in FIGS. 1, 4 and 7, the second heat exchanger 28 is configured to cool a product material exiting the calciner 22 and/or the kiln 32 and transfer heat to the first heat exchanger 26. Air is used as a heat transfer medium between heat exchanger 26 and heat exchanger 28. However, other kinds of appropriate heat transfer fluids such as steam and an inert gas can be also used. In the embodiments shown in FIGS. 2, 3, 5, 6, 8 and 9, the second heat exchanger 28 is configured to heat raw material to be fed to the calciner 22.

The calcination apparatus 20 is particularly suitable for use as an apparatus for lime (CaO) production (FIGS. 1, 2 and 3), although it is also equally suited to other calcination processes as well.

The calcination apparatus 20 is also particularly suitable for cement clinker production when used in conjunction with a kiln 32 (FIGS. 4 to 9). The kiln 32 accepts lime from the calcination apparatus 20 and produces cement clinker using known processes and protocols. However, the kiln 32 is configured to be heated by combustion of a carbon-based fuel or a hydrogen-based fuel and a hydrogen peroxide oxidant.

The calcination apparatus 20 can be used as part of a system for mitigating carbon dioxide emission levels during the manufacture of lime or cement clinker.

The present disclosure also provides a process for calcining a raw material to produce a calcined product. The process comprises introducing the raw material to a calcination apparatus 20 and heating the raw material in the calcination apparatus 20 using heat generated from combustion of a carbon-based fuel and a hydrogen peroxide oxidant composition under conditions to produce the calcined product.

The calcination apparatus that is used may be a calcination apparatus 20 as described herein.

The hydrogen peroxide oxidant may be as described herein. The hydrogen peroxide oxidant may be an aqueous hydrogen peroxide solution having a hydrogen peroxide mass fraction of ≥40 wt. %. The aqueous hydrogen peroxide solution may be in liquid and/or gaseous form.

The process also comprises evaporating an aqueous hydrogen peroxide solution to produce a gaseous hydrogen peroxide oxidant. The aqueous hydrogen peroxide solution can be evaporated and/or concentrated by heating the aqueous hydrogen peroxide solution using hot gases from the calcination apparatus.

The process also comprises heating the raw material prior to introduction to the calcination apparatus 20 using heat from the calcined product.

Further details of the apparatus 20, systems and processes described herein are provided in the following non-limiting examples.

### EXAMPLES

Throughout the following examples and the accompanying figures, the term ‘HP’ is used to denote hydrogen peroxide.

### Example 1—Lime Production Using Hydrogen Peroxide

Carbon (C) and methane (CH₄) were selected as surrogates for coal/biomass and natural gas fuels, respectively. That is, while being simpler to analyse, C is the primary component of coal/biomass and CH₄ is the primary component of natural gas. The combustion reactions of C and CH₄ with HP (Eqs. 3 and 4) and air (Eqs. 5 and 6) are as follows:

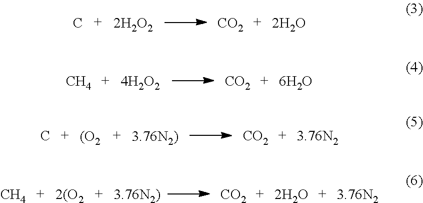

The AQ process, known also as the auto-oxidation process, currently accounts for more >95% of the global HP production (Yi et al. 2016). It comprises consecutive hydrogenation and oxidation steps in an organic solvent. In this process, the anthraquinone, as the reaction carrier, is first hydrogenated to the corresponding hydroquinone with hydrogen. After separation, the hydroquinone is oxidized with O₂ from the air to produce H₂O₂ along with anthraquinone, which is then re-circulated to the hydrogenation reactor. Afterwards, H₂O₂ is extracted from the organic solvent by water to produce an aqueous solution of HP, which is then concentrated via distillation (Yang et al. 2018). Currently, the required H₂ in the anthraquinone process is mainly produced from fossil fuel resources e.g. steam methane reforming and coal/biomass gasification. However, if the produced CO₂ through the production of HP is captured or HP is produced using renewable energy resources the associated CO₂ emissions would be significantly mitigated, which, in turn, would lead to the mitigation of CO₂ emissions. Importantly also, new technologies are emerging for direct HP production such as photoelectrochemical (PEC) and electrochemical water splitting, in which H₂ is produced in cathode and HP in anode. Commensurate with this, a recent study on the production of HP at the anode of a PEC water splitting process demonstrated the financial advantages of replacing oxygen at the anode with HP (Yang et al. 2018). This also enables the on-site production of HP, which could offer further financial advantages.

### Process Configuration

The highly endothermic calcination of CaCO₃ (as the main component of lime stone) to CaO (Eq. 1) is the main chemical reaction involved in the lime making process, which occurs at a temperature of about 850° C. typically within a kiln reactor. The crushed lime stone is preheated and dried by the hot exit gases from the kiln in a tower of heat exchanger cyclones. The fuel is burned in the kiln using air that is preheated with heat recovered from the hot lime product. The use of the preheater improves the thermal efficiency of the process. On this basis, a process configuration is shown in FIG. 1 for the use of HP as O₂ supplier in a lime production process, which is referred to as hydrogen peroxide fuel oxidation in calciner (HPFOX_{C}).

FIG. 1 shows an exemplary HPFOX_{C} apparatus 20 and process. The apparatus 20 comprises a calciner 22, a hydrogen peroxide boiler unit 24 and two gas-solid heat exchangers 26 and 28. In the process shown in FIG. 1, the heat recovered from the hot lime product (Stream 4) is used to preheat the inlet raw material (Stream 8). Air (Stream 5) is heated whilst simultaneously cooling of the product in the second heat exchanger 28 (HX2), and then transferred to the first heat exchanger 26 (HX1) to heat the inlet raw material. The preheated raw material (Stream 9) is then introduced into the calciner 22. This is in contrast to the conventional lime production processes, in which the heat recovered from the hot lime product is typically used to preheat the combustion air for the main burner in the calciner 22 (Boateng 2015).

In another heat-recovery process, the hot flue gas from the calciner 22 (Stream 3) is utilised to evaporate the inlet HP-water solution (Stream 10), within the hydrogen peroxide boiler unit 24. The evaporated HP solution (Stream 2) is then utilised to supply oxidiser to the calciner 22. The evaporation of aqueous HP within a shell and tube heat exchanger using the hot exhaust gas from a reactor has previously been demonstrated for gasification of heavy hydrocarbons (Han, Lee, and Bae 2015; Han et al. 2016).

FIG. 2 shows an alternative apparatus 20 and process for hydrogen peroxide fuel oxidation in calciner 22 (HPFOX_{C}), in which the hot steam leaving the calciner 22 (Stream 3) is utilised to preheat the inlet raw material (Stream 11). In this process, the heat recovered from the hot lime product (Stream 4) is used to evaporate the inlet hydrogen peroxide (Stream 8) via a direct solid-to-gas heat exchanger 26 (HX1) using air and a boiler 24. Air (Stream 5) is heated whilst simultaneously cooling of the product in the first heat exchanger (HX1) 26, and then transferred to the second heat exchanger, which is a boiler (HP Boiler) 24 to preheat and evaporate the inlet hydrogen peroxide mixture.

FIG. 3 shows an alternative apparatus 20 and process for hydrogen peroxide fuel oxidation in calciner 22 (HPFOX_{C}), in which the hydrogen peroxide-water mixture is directly introduced (sprayed/atomised) into the calciner 22. The apparatus 20 can also include a catalyst bed, activating and facilitating the dissociation of the hydrogen peroxide-water mixture. This can also be applied to all other configurations. The hot steam leaving the calciner (Stream 3) is at high temperatures and can be utilised for example to generate electricity or supply process heat. In this process, the heat recovered from the hot lime product (Stream 4) is used to preheat the inlet raw material (Stream 8), via two direct solid-to-gas heat exchangers 26 and 28 (HX1 and HX2) and air (Streams 5 and 6).

The estimated temperature, composition and normalised flow rates of the various streams of the HPFOX_{C} process are presented in Tables 1 and 2 for CH₄ and C as fuels and the reference operating conditions shown in Table 3. In these Tables, \dot{m}ᵢ is the mass flow rate of stream i. The mass flow rates of all streams are also normalised by that of the product lime (e.g. Stream 12 in FIG. 1). In all cases, the equilibrium calculations show that CaCO₃ is fully converted to CaO within the calciner while the fuel is almost entirely converted to CO₂ and H₂O so that the mole fractions of any trace fuels (CO, H₂, CH₄ and C) are less than 0.001. (The smallest of these are not shown in these Tables). Moreover, the calculations show that HP in all cases is decomposed completely to H₂O and O₂.

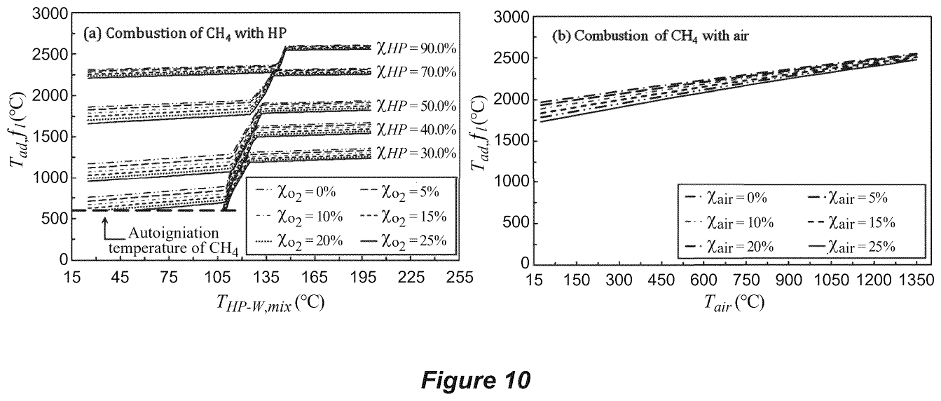

FIG. 10(a) presents the calculated dependence of the adiabatic flame temperature, T_{ad,fl}, on the temperature of the HP—H₂O mixture, T_{HP-W,mix}, for the combustion of CH₄ with a HP—H₂O mixture for both various concentrations of HP in H₂O, ω_{HP}, and various excess oxygen ratios supplied from HP dissociation, χ_{O}_{₂}. As expected, T_{ad,fl} increases with T_{HP-W,mix} over the whole range of ω_{HP} and χ_{O}_{₂}_{,HP} assessed. Importantly, for an χ_{O}_{₂}≥40% a region can be seen in which the value of T_{ad,fl} changes steeply for all cases at T_{HP-W,mix}≈125° C., while the slope on either side of this region is low. For example, for a HP-water mixture with an ω_{HP}=40 wt. % and an χ_{O}_{₂}_{,HP}=15%, the estimated T_{ad,fl} increases gradually from 626° C. at T_{HP-W,mix}=25° C. to 771° C. at T_{HP-W,mix}=110° C., while the magnitude changes steeply at T_{HP-W,mix}=127.5° C. by some 729° C. to T_{ad,fl}=1500° C. This near step-change can be attributed to the need to vaporise the liquid HP solution. Adiabatic flame temperatures of less than the minimum auto-ignition temperature of CH₄ (600° C. in air) are not shown in FIG. 10(a).

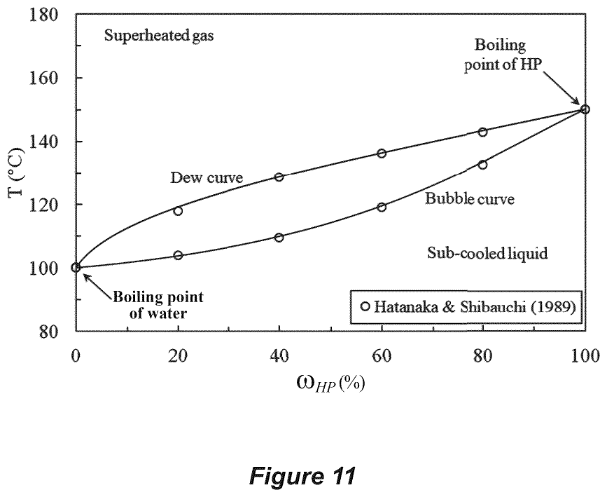

FIG. 11 presents the estimated atmospheric bubble and dew point diagrams of an aqueous HP solution as a function of χ_{HP}. The areas above the dew curve and under the bubble curve in FIG. 11 are associated with the superheated gas and subcooled liquids, respectively, while the area in between the dew and bubble curves represents the saturated two-phase gas and liquid mixtures. This shows that the region to the left of the step change in T_{ad,fl} from FIG. 10(a) is associated with introducing a subcooled liquid to the reaction, so that the latent heat of evaporation must be supplied from the LHV of fuel and enthalpy of dissociation of HP before the dissociation reaction can occur. In contrast, the right-hand side of the step change in T_{ad,fl} the HP-solution is associated with reaction of a superheated HP—H₂O gaseous mixture, which needs to be sensibly heated to the reaction temperature. However, latent heat of evaporation of the HP—H₂O mixture is significantly higher than the sensible heat of the associated gaseous mixture. Commensurate with this, through the step-change in T_{ad,fl} the HP solution is a saturated mixture of liquid and gas, with a high liquid content at the vicinity of the bubble curve and a high gas fraction close to the dew curve. Also consistent with expectation, the value of T_{ad,fl} is calculated to increase with an increase in the HP content of the HP—H₂O mixture (FIGS. 10(a) and 11). FIG. 11 also shows that the boiling point of pure HP is ˜150° C., which is approximately 50° C. higher than that of pure water. That is the temperature at which the step change in adiabatic flame temperature (FIG. 10(a)) occurs was found to increase with the HP content of the HP—H₂O mixture. It can also be seen that the magnitude of the latent heat of evaporation of H₂O (2258 KJ/kg at 100° C. and 1 atm) is significantly higher than that of H₂O₂ (1372 KJ/kg at 150° C. and 1 atms). Hence, mixtures of HP—H₂O with a high concentration of HP (high values of χ_{HP}) require less heat to be evaporated relative to those with a low concentration of HP in water (low χ_{HP} values). This explains why the adiabatic flame temperature increases with the HP content of the mixture.

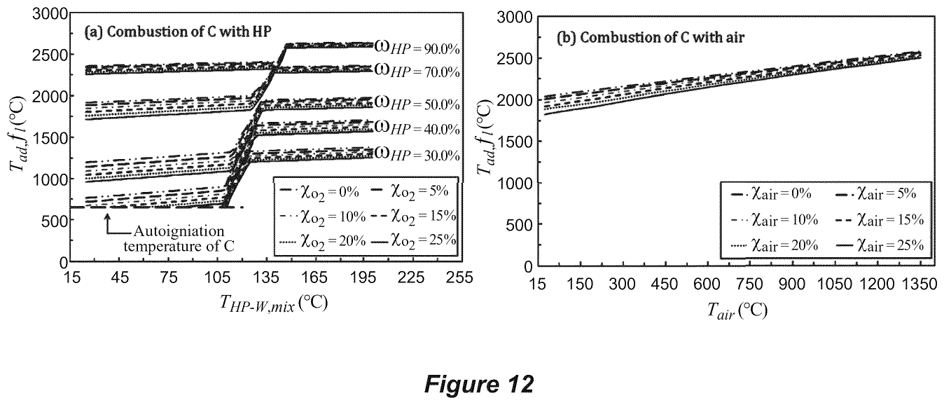

FIG. 12(a) shows the calculated dependence of the adiabatic flame temperature, T_{ad,fl}, on the temperature of the HP—H₂O mixture, T_{HP-H}_{₂}_{O,mix}, for the combustion of carbon (C) with HP—H₂O mixture for both various concentrations of HP in H₂O, χ_{HP}, and various excess oxidant ratios, χ₀₂. As shown the sensitivities of T_{ad,fl} to χ_{HP} and χ₀₂ are similar to those of the combustion of CH₄ with HP (FIG. 10(a)), while also the values of T_{ad,fl} are relatively similar to those for the combustion of CH₄ and HP.

For comparison, the estimated adiabatic flame temperature, T_{ad,fl}, of CH₄ and C with air as a function of the air temperature, Tₐᵢᵣ, for various values of excess air, χₐᵢᵣ, are shown in FIGS. 10(b) and 12(b), respectively. As can be seen, for HP solutions with χ_{HP}>˜40 wt. %, the estimated T_{ad,fl} for the combustion of CH₄ and C with evaporated HP—H₂O mixture (i.e. T_{HP-W,mix}>˜110° C.) is in the same range as those of the combustion of CH₄ and C with the preheated air. The maximum estimated adiabatic flame temperature for the combustion of CH₄ and C using a 40 wt. % HP—H₂O mixture is ˜1674° C. for χ₀₂=0% and 1570° C. for an χ₀₂=25% (FIGS. 10(a) and 10(b)). This temperature range is >˜700° C. higher than the temperature of the calcination reaction, which is ˜850° C. for a CO₂ pressure of 0.5 bar. As shown in FIGS. 10(a) and 12(a), the latent heat of evaporation of the HP—H₂O mixture significantly affects the adiabatic flame temperature. That is in the HPFOX_{C} cycle (e.g. FIG. 1), the boiler unit 24 evaporates the inlet HP—H₂O mixture prior to its introduction into the reactors 22, using the heat recovered from the flue gases of the reactors 22. On the other hand, previous investigations have shown that if the gaseous concentration of HP in the solution exceeds 40 wt. % (0.26 mole fraction) at atmospheric pressure, in the presence of sufficient energy, the risk of deflagration and detonation of HP increases significantly. Thus a 40 wt. % gaseous concentration of HP is reported as the lower flammability or explosive limit for the HP—H₂O mixture (Liu et al. 2019; Hâncu et al. 2002). In spite of this, successful evaporation and use of HP—H₂O mixture of 50 wt. % for gasification of heavy hydrocarbons has been demonstrated previously (Bosoaga, Masek, and Oakey 2009; (Chen et al. 2011; Wang et al. 2019). Moreover, the use of HP as an oxidant mitigates the soot fraction in the flame, while the presence of soot in flame significantly increases its emissivity.

The calculations show that an evaporated aqueous HP solution with a HP mass fraction of ≥40 wt. % enables adiabatic flame temperatures of >˜1550° C., which is some 700° C. higher than the temperature of the calcination reaction and potentially enables enough heat transfer to drive the calcination reaction. The calculations also show that it is thermodynamically feasible to use HP—H₂O solution for CO₂ capture in lime production process.

For the reference operating conditions considered the simulations predict that ˜67% and ˜72% of the total CO₂ emissions are captured if the HP—H₂O mixture is supplied from AQ process with a CO₂ emission of 0.535 kg_{CO2}/kg_{HP}. Nevertheless, a full capture of CO₂ can be achieved if HP is produced with no CO₂ emissions. Moreover, the calculations also show that with the reference operating conditions the cycle can achieve an efficiency of ˜46%, while ˜77% of the energy is supplied from fuel and the rest comes from dissociation of HP. The sensitivity analysis found that:
Increasing of the mass fraction of HP in HP—H₂O mixture increases the CO₂ avoided, net CO₂ captured and efficiency of the cycle. However, the net CO₂ captured is less sensitive to the mass fraction of HP in HP—H₂O mixture if HP is supplied with no CO₂ emissions, i.e. from renewable resources or through integration of CO₂ capture to HP production process, or though electro-chemical process involving water and O₂;
An increase in the excess oxygen decreases both the net CO₂ captured and the cycle efficiency.

### Example 2—Cement Production Using HP

There are two main chemical reactions involved in the cement making process. The first step is the highly endothermic calcination of lime stone to lime (Eq. 1), which occurs at a temperature of about 850° C. In the second step, the temperature of the lime product is further increased to about 1450° C. to drive the slightly exothermic clinkering reactions. Prior to entering the kiln of a modern process, the crushed raw material is preheated, dried and typically partially calcined by the hot exit gases from the kiln in a tower of heat exchanger cyclones. The calcination process is then completed in a special combustion chamber, which is referred to as the calciner, prior to the kiln. The fuel is burned in this chamber using air that is preheated with heat recovered from the hot product. The use of the preheater and calciner improve the thermal efficiency of the cement production process, facilitate the use of a wide range of fuels, improve the clinker product quality and prolongs the lifetime of brick lining (Newman and Choo 2003). On this basis, the two general process configurations selected for the use of HP as O₂ supplier in cement production process are the hydrogen peroxide fuel oxidation in calciner and kiln (HPFOX_{C+K}) and the hydrogen peroxide fuel oxidation in calciner (HPFOX_{C}).

### Hydrogen Peroxide Fuel Oxidation in Kiln and Calciner (HPFOX_{C+K}) for Cement Production

FIG. 4 shows the components of a thermodynamic HPFOX_{C+K} cycle, in which HP provides O₂ both for the calciner 22 and the kiln 32. In this process the heat recovered from the hot clinker (Stream 7) is used to preheat the inlet raw material (Stream 14). Air (Stream 9) is heated whilst simultaneously cooling of the product in the second heat exchanger (HX2) 28, and then transferred to the first heat exchanger (HX1) 26 to heat the inlet raw material. The preheated raw material (Stream 12) is then introduced into the calciner 22. It is worth noting that this configuration for heat recovery from hot product (Stream 7) is in contrast to the conventional cement production systems, in which the heat recovered from the hot clinker product is typically used to preheat the secondary air for the main burner in kiln 32 and the tertiary air for the calciner 22 (Boateng 2015).

Similarly, in another heat-recovery process shown in FIG. 4, the hot flue gas from both the kiln 32 and calciner 22 (Stream 15, which is a combination of Streams 3 and 6, respectively) is utilised to evaporate the inlet HP solution (Stream 17), within the HP boiler 24. The evaporated HP solution (Stream 2) is then utilised to supply oxidiser to both the calciner 22 and the kiln 32 via Streams 16 and 8, respectively. An aqueous HP mixture with a mass faction of 50 wt. % can provide adiabatic flame temperatures of >1825° C. It is worth noting that the evaporation of HP up to a concentration of 50 wt. % within a shell and tube heat exchanger using the hot exhaust gas from a reactor has been demonstrated by Han et al. (Han et al. 2016; Han, Lee, and Bae 2015). The calcined material leaving the calciner 22 (Stream 4), is heated to a temperature of 1450° C. within the kiln 32, producing clinker.

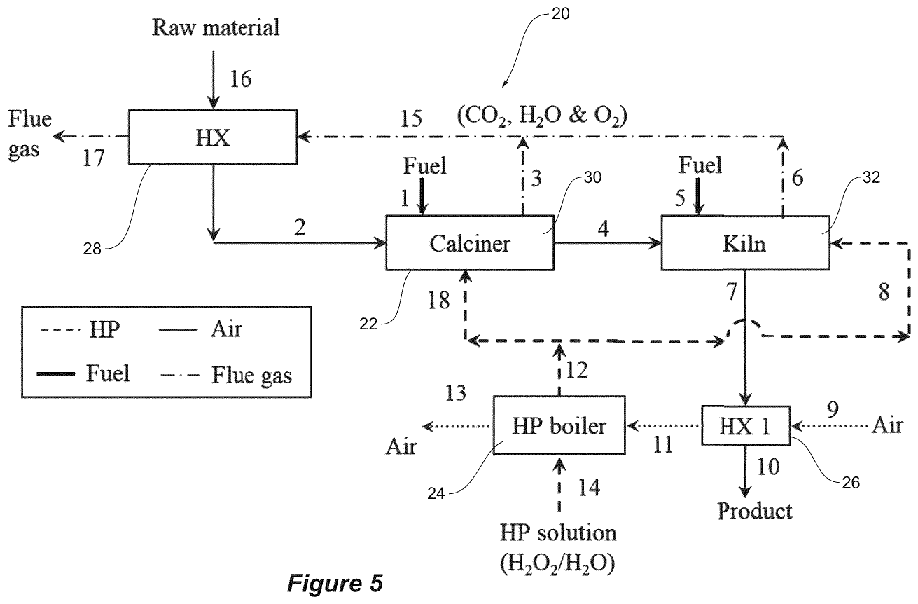

FIG. 5 shows an alternative apparatus 20 and process configuration for the use of HP in calciner 22 and kiln 32 of a cement production process. This process is a hydrogen peroxide fuel oxidation in calciner and kiln (HPFOX_{C+K}). In this process, the heat recovered from the hot clinker (Stream 7) is used to evaporate the hydrogen peroxide and water mixture (Stream 14) using air as an intermediate heat transfer medium, employing a first heat exchanger 26 (HX1) and a boiler 24. Air (Stream 9) is heated whilst simultaneously cooling of the product in the first heat exchanger 26, and then transferred to the HP boiler 24 to evaporate the inlet aqueous HP mixture. The evaporated HP solution (Stream 12) is utilised to supply oxidiser to both the calciner 22 and the kiln 32 via Streams 8 and 18, respectively. Similarly, in another heat-recovery process, the hot flue gas from both the kiln 32 and calciner 22 (Stream 15, which is a combination of Streams 3 and 6) is utilised to preheat inlet raw material (Stream 16) using the second heat exchanger (HX) 28. The preheated raw material (Stream 2) is then introduced into the calciner 22.

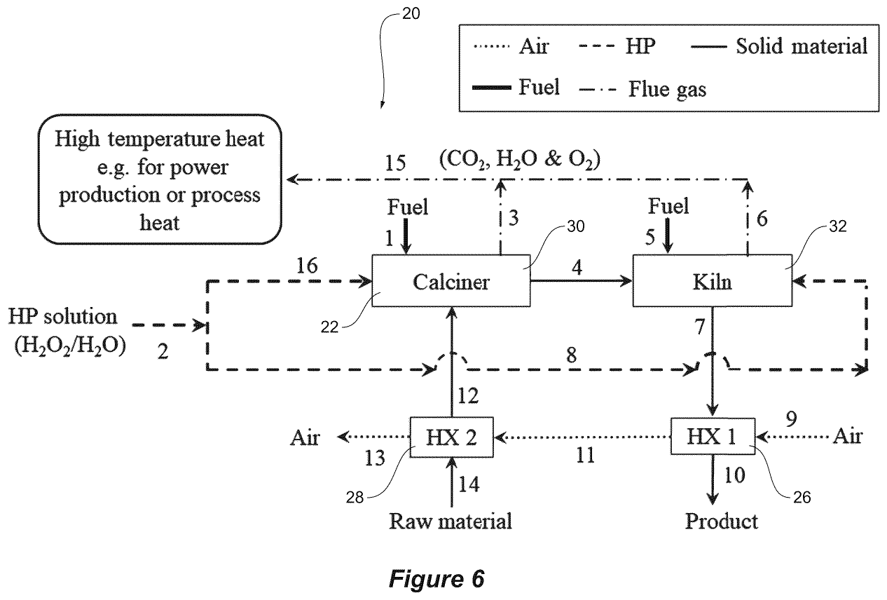

FIG. 6 shows an alternative apparatus 20 and process configuration for the use of HP in calciner 22 and kiln 32 of a cement production process. This process is a hydrogen peroxide fuel oxidation in calciner and kiln (HPFOX_{C+K}). In this process, the hydrogen peroxide-water mixture is directly introduced (sprayed/atomised) into both the kiln 32 and the calciner 22. The heat recovered from the hot clinker (Stream 7) is used to preheat the raw materials (Stream 14). Air (Stream 9) is heated whilst simultaneously cooling the product in the first heat exchanger (HX1) 26, and then transferred to the second heat exchanger (HX2) 28 to preheat the inlet raw material. The gas leaving the calciner 22 (Stream 3) and kiln 32 (Stream 6) can be used for power generation or to supply process heat.

### Hydrogen Peroxide Fuel Oxidation (HPFOX_{C}) for Cement Production

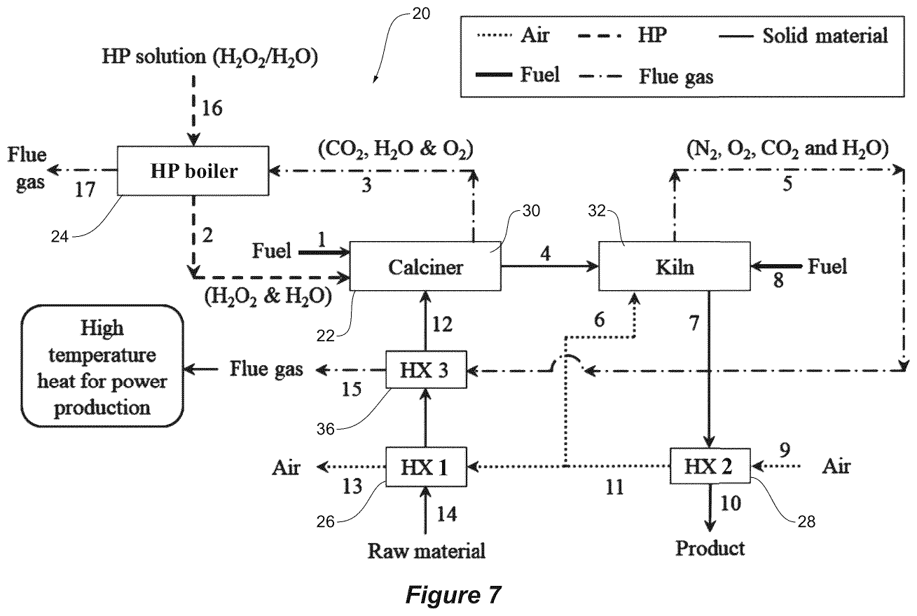

FIG. 7 shows an apparatus 20 and process configuration for a thermodynamic HPFOX_{C} cycle for cement production. This process configuration was developed because the large majority of the CO₂ emissions from cement plants are generated from the calcination of limestone itself (Eq. 1) within the calciner 22. Hence, for this configuration, HP is only used to meet the O₂ demand of the calciner 22, while that for the kiln 32 is supplied from the pre-heated air (Stream 6). This avoids changing the heat recovery process that is standard in the industry in which the heat of hot clinker (Stream 7) is recovered to preheat air which is then used both to supply the O₂ demand of the kiln 32 and to preheat the raw material (Stream 14) using two heat exchangers 26 and 28 (HX1 and HX2). The hot flue gas leaving the kiln 32 (Stream 5) is also used to further preheat the raw materials using a third heat exchanger (HX3) 36, prior to being introduced into the calciner 22. The gas leaving the third heat exchanger (HX3) 36 can be at a sufficiently high temperature to be used for power generation.

Another alternative of an apparatus 20 and process configuration for a thermodynamic HPFOX_{C} cycle for cement production is shown in FIG. 8. For this configuration, HP is only used to meet the O₂ demand of the calciner 22, while that for the kiln 32 is supplied from the pre-heated air (Stream 6). This again avoids changing the heat recovery process that is standard in the industry in which the heat of hot clinker (Stream 7) is recovered to preheat air (Stream 9) using heat exchanger (HX1) 26 and the preheated air is then used to supply the O₂ demand of the kiln 32 (Stream 6). The hot flue gas leaving the kiln 32 (Stream 5) is used to evaporate the inlet aqueous HP solution via HP boiler 24, prior to being introduced into the calciner 22 (Stream 12), while the hot flue gas leaving the calciner 22 (Stream 3) is utilised to preheat the inlet raw material (Stream 15) via heat exchanger (HX3) 28.

FIG. 9 shows another alternative apparatus 20 and process configuration for a thermodynamic HPFOX_{C} cycle for cement production in which the O₂ demand of the calciner 22 is supplied with a mixture of HP and water. In this process, inlet air (Stream 9) is preheated by the heat recovered from the hot product (Stream 7) using heat exchanger (HX1) 26. A fraction of the preheated air (Stream 15) is utilised to preheat/evaporate the inlet HP solution (Stream 17) via HP Heater/Boiler 38, while the rest (Stream 6) is used to supply the combustion air demand of the kiln 32. The hot flue gas leaving the kiln (Stream 5) is used to evaporate the preheated HP solution (Stream 14) via the HP boiler 24, prior to its introduction to the calciner 22 (Stream 12). The hot gas leaving the calciner 22 (Stream 3) is utilised to preheat the raw material (Stream 18) via heat exchanger (HX3) 28.

The estimated temperature, compositions and normalised flow rates of the various streams of the HPFOX_{C+K} and HPFOX_{C} processes (FIGS. 4 to 9) for CH₄ and C as fuels and the reference operating conditions (Table 3) are presented in Tables 4 to 7. In these Tables, m′ᵢ is the mass flow rate of stream i. The mass flow rate of all streams are also normalised to that of the outlet product (Stream 10 in FIGS. 4 to 9). In all assessed cases, the equilibrium calculations show that CaCO₃ is fully converted to CaO within the calcination reactors 22, the fuel is almost entirely converted to CO₂ and H₂O and the mole fractions of produced CO, H₂ and unreacted fuels CH₄ and C are less than 0.001. The mole fractions of CH₄, CO, H₂, H₂O₂ and C in the outlet streams from the reactors are not shown in Tables 4 to 7. Moreover, the calculations show that HP in all cases has been decomposed completely to H₂O and O₂.

The use of an aqueous HP solution for CO₂ capture in cement production has been found to have significant thermodynamic potential for efficient CO₂ capture, although the net CO₂ emissions and CO₂ capture efficiency of the assessed cycles significantly depend on the net CO₂ emission associated with the HP production. The equilibrium calculations also estimate that the evaporated HP—H₂O mixture can fully combust the fuel and provide the required heat within the calciner and kiln reactors. Moreover, the HPFOX_{C+K} and HPFOX_{C} cycles can achieve a first-law efficiency of ˜35% and 43%, respectively, with CH₄ and C as fuel. Moreover, the calculations show that the assessed HPFOX_{C+K} and HPFOX_{C} cycles can reduce the net CO₂ emission by ˜50%, even with the HP produced from AQ process with some CO₂ emission of 0.534 kgCO₂/kgHP.

In summary, the apparatus, systems and processes disclosed herein: (1) Enable efficient heat recovery whilst achieving continuous CO₂ capture from high temperature processes, such as calcination and cement production processes; (2) Can be retrofitted to existing calcination processes for cement and lime production processes without the need for a major modification; (3) Enable almost complete capture of CO₂ with similar efficiency to current processes, and with the potential to lower costs over the state-of-the-art energy intensive CO₂ capture technologies that require high costs to achieve 90% CO₂ capture; (4) Offer potential for a net CO₂ sink, if both hydrogen peroxide and fuels are produced from renewable energy sources; and (5) Offer the ability to capture >90% of the water which can be reused for the production of HP using renewable sources.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

Table 1. Temperature and composition of various streams of the proposed HPFOX_{C} for lime production with CH₄ as fuel. The flow rates of all streams are normalised to that of the product lime stream (Stream 12 in FIG. 1).

| | | | | | | | | | Liquid | | | | | | | | | |
|---|---|---|---|---|---|---|---|---|---|---|---|---|---|---|---|---|---|---|
| | | | Gas phase | | | | | | phase | | Solid phase | | | | | | | |
| Stream No. | Temperature (° C.) | ${\dot{m}}_{i} / {\dot{m}}_{12} ( \frac{kg}{kg} )$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.074 | | | | | 1.0 | | | | | | | | | | | |
| 2 | 160 | 1.74 | | | | 0.26 | | 0.74 | | | | | | | | | | |
| 3 | 850 | 2.363 | | 0.009 | 0.162 | 0.829 | | | | | | | | | | | | |
| 4 | 850 | 1.0 | | | | | | | | | | 0.668 | 0.046 | 0 | 0.022 | 0.047 | 0 | 0.217 |
| 5 | 25 | 0.981 | 0.79 | 0.21 | | | | | | | | | | | | | | |
| 6 | 750 | 0.981 | 0.79 | 0.21 | | | | | | | | | | | | | | |
| 7 | 100 | 0.981 | 0.79 | 0.21 | | | | | | | | | | | | | | |
| 8 | 25 | 1.55 | | | | | | | | | 0.77 | | 0.03 | 0.03 | | 0.03 | | 0.14 |
| 9 | 473 | 1.55 | | | | | | | | | 0.77 | | 0.03 | 0.03 | | 0.03 | | 0.14 |
| 10 | 25 | 1.74 | | | | | | | 0.4 | 0.6 | | | | | | | | |
| 11 | 93 | 2.363 | | 0.009 | 0.162 | 0.829 | | | | | | | | | | | | |
| 12 | 100 | 1.0 | | | | | | | | | | 0.668 | 0.046 | 0 | 0.022 | 0.047 | 0 | 0.217 |

‘yᵢ’ is the mole fraction of component i in the gas phase.
‘xᵢ’ is the mass fraction of component i in either solid or liquid phases.

Table 2. Temperature and composition of various streams of the assessed HPFOX_{C} for lime production with C as fuel. The flow rate of all streams are normalised to that of the product lime stream (Stream 12 in FIG. 1).

| | | | | | | | | | Liquid | | | | | | | | | |
|---|---|---|---|---|---|---|---|---|---|---|---|---|---|---|---|---|---|---|
| | | | Gas phase | | | | | | phase | | Solid phase | | | | | | | |
| Stream No. | Temperature (° C.) | ${\dot{m}}_{i} / {\dot{m}}_{12} ( \frac{kg}{kg} )$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.11 | | | | | | | | 1.0 | | | | | | | | |
| 2 | 160 | 1.715 | | | | 0.26 | 0.74 | | | | | | | | | | | |
| 3 | 850 | 2.374 | | 0.009 | 0.217 | 0.774 | | | | | | | | | | | | |
| 4 | 850 | 1.0 | | | | | | | | | | 0.668 | 0.046 | 0 | 0.022 | 0.047 | 0 | 0.217 |
| 5 | 25 | 0.981 | 0.79 | 0.21 | | | | | | | | | | | | | | |
| 6 | 750 | 0.981 | 0.79 | 0.21 | | | | | | | | | | | | | | |
| 7 | 100 | 0.981 | 0.79 | 0.21 | | | | | | | | | | | | | | |
| 100 | 25 | 1.55 | | | | | | | | | 0.77 | | 0.03 | 0.03 | | 0.03 | | 0.14 |
| 8 | | | | | | | | | | | | | | | | | | |
| 9 | 473 | 1.55 | | | | | | | | | 0.77 | | 0.03 | 0.03 | | 0.03 | | 0.14 |
| 10 | 25 | 1.715 | | | | | | 0.4 | 0.6 | | | | | | | | | |
| 11 | 90 | 2.374 | | 0.009 | 0.217 | 0.774 | | | | | | | | | | | | |
| 12 | 100 | 1.0 | | | | | | | | | | 0.668 | 0.046 | 0 | 0.022 | 0.047 | 0 | 0.217 |

‘yᵢ’ is the mole fraction of component i in the gas phase.
‘xᵢ’ is the mass fraction of component i in either solid or liquid phases.

Table 3. Assumptions employed in the analysis of the HPFOX_{C} and HPFOX_{C+K} cycles.

| | Reference operating |
|---|---|
| | conditions |
| Calciner | |
| Operating temperature (° C.) | 850 |
| Operating pressure (atm) | 1.0 |
| Inlet HP | |
| Temperature (° C.) | 25 |
| Pressure (atm) | 1 |
| Excess HP (%) | 5 |
| Partial oxy-fuel combustion | 40 |
| Temperature of the evaporated HP mixture | 160 |
| (stream 2 in Figures 1 and 2) | |
| Excess oxidiser (%) | 10 |
| Heat exchanger's stream temperatures | |
| Minimum temperature difference between | 100 |
| the outlet hot and cold streams from Direct | |
| air-particle heat exchanger (° C.) | |
| ${CO}_{2} emitted in production of HP ( \frac{{kg}_{{CO}_{2}}}{{kg}_{HP}} )$ | 0.534 |

Table 4. Temperature and composition calculated for the various streams of the HPFOX_{C+K} cycle for cement production with CH₄ as the fuel (FIG. 4). The flow rates of all streams are normalised to that of the product lime stream (Stream 10 in FIG. 4).

| | | | | | | | | | Liquid | | | | | | | | | |
|---|---|---|---|---|---|---|---|---|---|---|---|---|---|---|---|---|---|---|
| Stream | Temperature | | Gas phase | | | | | | phase | | Solid phase | | | | | | | |
| No. | (° C.) | ${\dot{m}}_{i} / {\dot{m}}_{14}$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.054 | | | | | 1.0 | | | | | | | | | | | |
| 2 | 160 | 1.850 | | | | 0.65 | | 0.35 | | | | | | | | | | |
| 3 | 850 | 1.602 | | 0.01 | 0.241 | 0.749 | | | | | | | | | | | | |
| 4 | 850 | 1.00 | | | | | | | | | | 0.668 | 0.046 | | 0.022 | 0.046 | | 0.217 |
| 5 | 25 | 0.046 | | | | | 1.0 | | | | | | | | | | | |
| 6 | 1450 | 0.898 | | 0.012 | 0.063 | 0.925 | | | | | | | | | | | | |
| 7 | 1450 | 1.0 | | | | | | | | | | 0.668 | 0.046 | | 0.022 | 0.046 | | 0.217 |
| 8 | 160 | 0.85 | | | | | | | | | | | | | | | | |
| 9 | 25 | 1.036 | 0.79 | 0.21 | | | | | | | | | | | | | | |
| 10 | 100 | 1.00 | | | | | | | | | | 0.668 | 0.046 | | 0.022 | 0.046 | | 0.217 |
| 11 | 1350 | 1.036 | 0.79 | 0.21 | | | | | | | | | | | | | | |
| 12 | 700 | 1.548 | | | | | | | | | 0.77 | | 0.03 | 0.03 | | 0.03 | | 0.14 |
| 13 | 430 | 1.036 | 0.79 | 0.21 | | | | | | | | | | | | | | |
| 14 | 25 | 1.548 | | | | | | | | | 0.77 | | 0.03 | 0.03 | | 0.03 | | 0.14 |
| 15 | 1098 | 2.497 | | 0.011 | 0.168 | 0.821 | | | | | | | | | | | | |
| 16 | 160 | 1.00 | | | | 0.65 | | 0.35 | | | | | | | | | | |
| 17 | 25 | 1.850 | | | | | | | 0.5 | 0.5 | | | | | | | | |
| 18 | 234 | 2.497 | | 0.011 | 0.168 | 0.821 | | | | | | | | | | | | |

Table 5. Temperature and composition calculated for the various streams of the HPFOX_{C+K} cycle for cement production with C as the fuel (FIG. 4). The flow rates of all streams are normalised to that of the product lime stream (Stream 10 in FIG. 4).

| | | | | | | | | | Liquid | | | | | | | | | |
|---|---|---|---|---|---|---|---|---|---|---|---|---|---|---|---|---|---|---|
| Stream | Temperature | | Gas phase | | | | | | phase | | Solid phase | | | | | | | |
| No. | (° C.) | ${\dot{m}}_{i} / {\dot{m}}_{14}$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.079 | | | | | | | | 1.0 | | | | | | | | |
| 2 | 160 | 1.755 | | | | 0.65 | 0.35 | | | | | | | | | | | |
| 3 | 850 | 1.615 | | 0.011 | 0.309 | 0.68 | | | | | | | | | | | | |
| 4 | 850 | 1.0 | | | | | | | | 0 | | 0.668 | 0.046 | | 0.022 | 0.046 | | 0.217 |
| 5 | 25 | 0.062 | | | | | | | | 1.0 | | | | | | | | |
| 6 | 1450 | 0.831 | | 0.013 | 0.134 | 0.852 | | | | | | | | | | | | |
| 7 | 1450 | 1.00 | | | | | | | | | | 0.668 | 0.046 | | 0.022 | 0.046 | | 0.217 |
| 8 | 160 | 0.769 | | | | 0.65 | 0.35 | | | | | | | | | | | |
| 9 | 25 | 1.034 | 0.79 | 0.21 | | | | | | | | | | | | | | |
| 10 | 100 | 1.00 | | | | | | | | | | 0.668 | 0.046 | | 0.022 | 0.046 | | 0.217 |
| 11 | 1350 | 1.034 | 0.79 | 0.21 | | | | | | | | | | | | | | |
| 12 | 700 | 1.548 | | | | | | | | | 0.77 | | 0.03 | 0.03 | | 0.03 | | 0.14 |
| 13 | 430 | 1.034 | 0.79 | 0.21 | | | | | | | | | | | | | | |
| 14 | 25 | 1.548 | | | | | | | | | 0.77 | | 0.03 | 0.03 | | 0.03 | | 0.14 |
| 15 | 1083 | 2.446 | | 0.012 | 0.242 | 0.746 | | | | | | | | | | | | |
| 16 | 160 | 0.986 | | | | 0.65 | 0.35 | | | | | | | | | | | |
| 17 | 25 | 1.755 | | | | | | 0.5 | 0.5 | | | | | | | | | |
| 18 | 183 | 2.446 | | 0.012 | 0.24 | 0.746 | | | | | | | | | | | | |

Table 6. Temperature and composition calculated for the various streams of the HPFOX_{C} for cement production with CH₄ as the fuel (FIG. 7). The flow rates of all streams are normalised to that of the product lime stream (Stream 10 in FIG. 7).

| | Temper- | | | | | | | | Liquid | | | | | | | | | |
|---|---|---|---|---|---|---|---|---|---|---|---|---|---|---|---|---|---|---|
| Stream | ature | | Gas phase | | | | | | phase | | Solid phase | | | | | | | |
| No. | (° C.) | ${\dot{m}}_{i} / {\dot{m}}_{14}$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.063 | | | | | 1.0 | | | | | | | | | | | |
| 2 | 160 | 1.477 | | | | 0.74 | | 0.26 | | | | | | | | | | |
| 3 | 850 | 2.087 | | 0.009 | 0.179 | 0.812 | | | | | | | | | | | | |
| 4 | 850 | 1.000 | | | | | | | | | | 0.668 | 0.046 | | 0.022 | 0.046 | | 0.217 |
| 5 | 1450 | 0.424 | 0.721 | 0.017 | 0.087 | 0.174 | | | | | | | | | | | | |
| 6 | 1350 | 0.402 | 0.79 | 0.21 | | | | | | | | | | | | | | |
| 7 | 1450 | 1.000 | | | | | | | | | | 0.668 | 0.046 | | 0.022 | 0.046 | | 0.217 |
| 8 | 25 | 0.021 | | | | | 1.0 | | | | | | | | | | | |
| 9 | 25 | 0.991 | 0.79 | 0.21 | | | | | | | | | | | | | | |
| 10 | 100 | 1.000 | | | | | | | | | | 0.668 | 0.046 | | 0.022 | 0.046 | | 0.217 |
| 11 | 1350 | 0.991 | 0.79 | 0.21 | | | | | | | | | | | | | | |
| 12 | 700 | 1.548 | | | | | | | | | 0.77 | | 0.03 | 0.03 | | 0.03 | | 0.14 |
| 13 | 100 | 0.000 | 0.79 | 0.21 | | | | | | | | | | | | | | |
| 14 | 25 | 1.548 | | | | | | | | | 0.77 | | 0.03 | 0.03 | | 0.03 | | 0.14 |
| 15 | 1047 | 0.424 | 0.72 | 0.017 | 0.087 | 0.176 | | | | | | | | | | | | |
| 16 | 25 | 1.477 | | | | | | | | | | | | | | | | |
| 17 | 93 | 2.087 | | 0.009 | 0.1790 | 0.812 | | | 0.26 | 0.74 | | | | | | | | |
| 18 | 573 | 1.548 | | | | | | | | | 0.77 | | 0.03 | 0.03 | | 0.03 | | 0.14 |
| 19 | 1350 | 0.588 | 0.79 | 0.21 | | | | | | | | | | | | | | |

Table 7. Temperature and composition calculated for the various streams of the HPFOX_{C} cycle for cement production with C as the fuel (FIG. 7). The flow rates of all streams are normalised to that of the product lime stream (Stream 10 in FIG. 7).

| | | | | | | | | | Liquid | | | | | | | | | |
|---|---|---|---|---|---|---|---|---|---|---|---|---|---|---|---|---|---|---|
| Stream | Temperature | | Gas phase | | | | | | phase | | Solid phase | | | | | | | |
| No. | (° C.) | ${\dot{m}}_{i} / {\dot{m}}_{14}$ | y_{N}_{₂} | y_{O}_{₂} | y_{CO}_{₂} | y_{H}_{₂}_{O} | y_{CH}_{₄} | y_{H}_{₂}_{O}_{₂} | x_{HP} | x_{w} | x_{CaCO}_{₃} | x_{CaO} | x_{AL}_{₂}_{O}_{₃} | x_{MgCO}_{₃} | x_{MgO} | x_{Fe}_{₂}_{O}_{₃} | x_{Fe}_{₃}_{O}_{₄} | x_{SiO}_{₂} |
| 1 | 25 | 0.077 | | | | | | | | | | | | | | | | |
| 2 | 160 | 1.455 | | | | 0.74 | 0.26 | | | | | | | | | | | |
| 3 | 850 | 2.096 | | 0.009 | 0.234 | 0.757 | | | | | | | | | | | | |
| 4 | 850 | 1.000 | | | | | | | | | | 0.668 | 0.046 | | 0.022 | 0.046 | | 0.217 |
| 5 | 1450 | 0.433 | 0.79 | 0.027 | 0.182 | | | | | | | | | | | | | |
| 6 | 1150 | 0.402 | 0.79 | 0.21 | | | | | | | | | | | | | | |
| 7 | 1450 | 0.992 | | | | | | | | | | 0.668 | 0.046 | | 0.022 | 0.046 | | 0.217 |
| 8 | 25 | 0.031 | | | | | | | | 1.0 | | | | | | | | |
| 9 | 25 | 1.037 | 0.79 | 0.21 | | | | | | | | | | | | | | |
| 10 | 100 | 1.000 | | | | | | | | | | 0.668 | 0.046 | | 0.022 | 0.046 | | 0.217 |
| 11 | 1350 | 0.992 | 0.79 | 0.21 | | | | | | | | | | | | | | |
| 12 | 700 | 1.548 | | | | | | | | | 0.77 | | 0.03 | 0.03 | | 0.03 | | 0.14 |
| 13 | 100 | 0.590 | 0.79 | 0.21 | | | | | | | | | | | | | | |
| 14 | 25 | 1.548 | | | | | | | | | 0.77 | | 0.03 | 0.03 | | 0.03 | | 0.14 |
| 15 | 1011 | 0.433 | 0.79 | 0.21 | | | | | | | | | | | | | | |
| 16 | 25 | 1.455 | | | | | | 0.4 | 0.6 | | | | | | | | | |
| 17 | 90 | 2.096 | | 0.009 | 0.237 | 0.757 | | | | | | | | | | | | |
| 18 | 90 | 1.867 | 1.0 | | | | | | | | 0.77 | | 0.03 | 0.03 | | 0.03 | | 0.14 |
| 19 | 1350 | 0.590 | 0.79 | 0.21 | | | | | | | | | | | | | | |

### REFERENCES

Boateng, A. A. 2015. Rotary Kilns: Transport Phenomena and Transport Processes (Elsevier Science).
Bosoaga, Adina, Ondrej Masek, and John E. Oakey. 2009. ‘CO2 Capture Technologies for Cement Industry’, Energy Procedia, 1: 133-40.
Buhre, B. J. P., L. K. Elliott, C. D. Sheng, R. P. Gupta, and T. F. Wall. 2005. ‘Oxy-fuel combustion technology for coal-fired power generation’, Progress in Energy and Combustion Science, 31:283-307.
Chen, Guan-Bang, Yueh-Heng Li, Tsarng-Sheng Cheng, Hung-Wei Hsu, and Yei-Chin Chao. 2011. ‘Effects of hydrogen peroxide on combustion enhancement of premixed methane/air flames’, International Journal of Hydrogen Energy, 36: 15414-26.
Ciriminna, Rosaria, Lorenzo Albanese, Francesco Meneguzzo, and Mario Pagliaro. 2016. ‘Hydrogen Peroxide: A Key Chemical for Today's Sustainable Development’, ChemSusChem, 9:3374-81.
Figueroa, José D., Timothy Fout, Sean Plasynski, Howard McIlvried, and Rameshwar D. Srivastava. 2008. ‘Advances in CO2 capture technology—The U.S. Department of Energy's Carbon Sequestration Program’, International Journal of Greenhouse Gas Control, 2: 9-20.
Fukuzumi, Shunichi, Yusuke Yamada, and Kenneth D. Karlin. 2012. ‘Hydrogen peroxide as a sustainable energy carrier: Electrocatalytic production of hydrogen peroxide and the fuel cell’, Electrochimica Acta, 82: 493-511.
Gardarsdottir, O. Stefania, Edoardo De Lena, Matteo Romano, Simon Roussanaly, Mari Voldsund, José-Francisco Pérez-Calvo, David Berstad, Chao Fu, Rahul Anantharaman, Daniel Sutter, Matteo Gazzani, Marco Mazzotti, and Giovanni Cinti. 2019. ‘Comparison of Technologies for CO2 Capture from Cement Production—Part 2: Cost Analysis’, Energies, 12.
Gerbelová, Hana, Mijndert van der Spek, and Wouter Schakel. 2017. ‘Feasibility Assessment of CO2 Capture Retrofitted to an Existing Cement Plant: Post-combustion vs. Oxy-fuel Combustion Technology’, Energy Procedia, 114: 6141-49.
Han, Gwangwoo, Kwangho Lee, Sanghyeon Ha, and Joongmyeon Bae. 2016. ‘Development of a thermally self-sustaining kWe-class diesel reformer using hydrogen peroxide for hydrogen production in low-oxygen environments’, Journal of Power Sources, 326: 341-48.
Han, Gwangwoo, Sangho Lee, and Joongmyeon Bae. 2015. ‘Diesel autothermal reforming with hydrogen peroxide for low-oxygen environments’, Applied Energy, 156:99-106.
Hâncu D, Green J, Beckman E J. H₂O₂ in CO₂: Sustainable Production and Green Reactions. Accounts of Chemical Research. 2002; 35:757-64.
Hatanaka, Koichi., and Yoshito. Shibauchi. 1989. “Sterilization method and apparatus therefor.” In. United States Patent.
Higginbotham, Paul, Vince White, Kevin Fogash, and Galip Guvelioglu. 2011. ‘Oxygen supply for oxyfuel CO2 capture’, International Journal of Greenhouse Gas Control, 5: S194-S203.
Kuan, Chih-Kuang, Guan-Bang Chen, and Yei-Chin Chao. 2007. ‘Development and Ground Tests of a 100-Millinewton Hydrogen Peroxide Monopropellant Microthruster’, Journal of Propulsion and Power, 23:1313-20.
Lin, H. T., Y. C. Chao, H. W. Hsu, C. A. Chen, G. B. Chen, and F. H. Wu. 2019. “Hydrogen peroxide revisited: The role as an energy-saving combustion enhancer and a non-toxic green propellant for satellites and hybrid rockets.” In 12^{th} Asia-Pacific Conference on Combustion, ASPACC 2019.
Liu, Jiali, Yousheng Zou, Bingjun Jin, Kan Zhang, and Jong Hyeok Park. 2019. ‘Hydrogen Peroxide Production from Solar Water Oxidation’, ACS Energy Letters, 4: 3018-27.
Lu, Zhiyi, Guangxu Chen, Samira Siahrostami, Zhihua Chen, Kai Liu, Jin Xie, Lei Liao, Tong Wu, Dingchang Lin, Yayuan Liu, Thomas F. Jaramillo, Jens K. Nørskov, and Yi Cui. 2018. ‘High-efficiency oxygen reduction to hydrogen peroxide catalysed by oxidized carbon materials’, Nature Catalysis, 1: 156-62.
Mota-Martinez, Maria T., Jason P. Hallett, and Niall Mac Dowell. 2017. ‘Solvent selection and design for CO2 capture—how we might have been missing the point’, Sustainable Energy & Fuels, 1: 2078-90.
Newman, J., and B. S. Choo. 2003. Advanced Concrete Technology Set (Elsevier Science).
Okninski, Adam, Pawel Surmacz, Bartosz Bartkowiak, Tobiasz Mayer, Kamil Sobczak, Michal Pakosz, Damian Kaniewski, Jan Matyszewski, Grzegorz Rarata, and Piotr Wolanski. 2021. ‘Development of Green Storable Hybrid Rocket Propulsion Technology Using 98% Hydrogen Peroxide as Oxidizer’, Aerospace, 8: 234.
Schneider, M., M. Romer, M. Tschudin, and H. Bolio. 2011. ‘Sustainable cement production—present and future’, Cement and Concrete Research, 41: 642-50.
Voldsund, Mari, Stefania Osk Gardarsdottir, Edoardo De Lena, José-Francisco Pérez-Calvo, Armin Jamali, David Berstad, Chao Fu, Matteo Romano, Simon Roussanaly, Rahul Anantharaman, Helmut Hoppe, Daniel Sutter, Marco Mazzotti, Matteo Gazzani, Giovanni Cinti, and Kristin Jordal. 2019. ‘Comparison of Technologies for CO2 Capture from Cement Production—Part 1: Technical Evaluation’, Energies, 12: 559.
Wang, Zhandong, Olivier Herbinet, Nils Hansen, and Frédérique Battin-Leclerc. 2019. ‘Exploring hydroperoxides in combustion: History, recent advances and perspectives’, Progress in Energy and Combustion Science, 73: 132-81.
Xue, Yudong, Yunting Wang, Zhenhua Pan, and Kazuhiro Sayama. 2021. ‘Electrochemical and Photoelectrochemical Water Oxidation for Hydrogen Peroxide Production’, Angewandte Chemie International Edition, 60: 10469-80.
Yang, Sungeun, Arnau Verdaguer-Casadevall, Logi Arnarson, Luca Silvioli, Viktor Čolić, Rasmus Frydendal, Jan Rossmeisl, Ib Chorkendorff, and Ifan E. L. Stephens. 2018. ‘Toward the Decentralized Electrochemical Production of H2O2: A Focus on the Catalysis’, ACS Catalysis, 8: 4064-81.
Yi, Yanhui, Li Wang, Gang Li, and Hongchen Guo. 2016. ‘A review on research progress in the direct synthesis of hydrogen peroxide from hydrogen and oxygen: noble-metal catalytic method, fuel-cell method and plasma method’, Catalysis Science & Technology, 6: 1593-610.

1. A calcination apparatus comprising a calciner configured to be heated by combustion of a carbon based fuel and a hydrogen peroxide oxidant.

2. The calcination apparatus as claimed in claim 1, further comprising a boiler unit for evaporating and/or concentrating an aqueous hydrogen peroxide solution to produce a gaseous hydrogen peroxide oxidant.

3. The calcination apparatus as claimed in claim 2, wherein the boiler unit evaporates the aqueous hydrogen peroxide solution by heating.

4. The calcination apparatus as claimed in claim 3, wherein the boiler unit is heated by hot gases from the calciner, hot gas leaving a kiln, gas that is heated electrically or gas that is heated using any heating source.

5. The calcination apparatus of claim 1, further comprising a first heat exchanger configured to heat raw material to be fed to the calciner.

6. The calcination apparatus as claimed in claim 5, further comprising a second heat exchanger configured to cool a product material exiting the calciner and transfer heat to the first heat exchanger.

7. An apparatus for lime (CaO) production, the apparatus comprising the calcination apparatus as claimed in claim 1.

8. An apparatus for cement clinker production, the apparatus comprising the calcination apparatus as claimed in claim 1 and a kiln configured to be heated by combustion of a carbon based fuel or a hydrogen-based fuel and a hydrogen peroxide oxidant composition.

9. A system for mitigating carbon dioxide levels during the manufacture of lime or cement clinker, the system comprising the calcination apparatus as claimed in claim 1.

10. A process for calcining a raw material to produce a calcined product, the process comprising:
introducing the raw material to a calcination apparatus; and
heating the raw material in the calcination apparatus using heat generated from combustion of a carbon based fuel and a hydrogen peroxide oxidant composition under conditions to produce the calcined product.

11. The process as claimed in claim 10, comprising evaporating and/or concentrating an aqueous hydrogen peroxide solution to produce a gaseous hydrogen peroxide oxidant.

12. The process as claimed in claim 11, comprising evaporating the aqueous hydrogen peroxide solution by heating.

13. The process as claimed in claim 12, comprising heating the aqueous hydrogen peroxide solution using hot gases from the calcination apparatus, hot gas leaving a kiln, gas that is heated electrically or gas that is heated using any heating source.

14. The process as claimed in claim 10, comprising heating the raw material prior to introduction to the calcination apparatus.

15. The process as claimed in claim 14, comprising heating the raw material using heat from the calcined product.

16. The process as claimed in claim 10, wherein the raw material is limestone and the conditions are selected to produce lime.

17. The process as claimed in claim 16, comprising evaporating an aqueous hydrogen peroxide solution to produce a gaseous hydrogen peroxide oxidant.

18. The process as claimed in claim 17, comprising evaporating and/or concentrating the aqueous hydrogen peroxide solution by heating.

19. The process as claimed in claim 18, comprising heating the aqueous hydrogen peroxide solution using hot gases from the calcination apparatus, hot gas leaving a kiln, gas that is heated electrically or gas that is heated using any heating source.

20. The process as claimed in claim 16, comprising heating the limestone prior to introduction to the calcination apparatus.

21. The process as claimed in claim 20, comprising heating the raw material using heat from the calcined product.

22. The process as claimed in claim 10, wherein the raw material is and the conditions are selected to produce a lime, the process further comprising:
heating the lime in a kiln to produce a clinker.

23. The process as claimed in claim 22, further comprising heating the lime in the kiln using heat generated from the combustion of the carbon based fuel and the hydrogen peroxide oxidant composition.

24. The process as claimed in claim 22, further comprising evaporating an aqueous hydrogen peroxide solution to produce a gaseous hydrogen peroxide oxidant.

25. The process as claimed in claim 24, comprising evaporating the aqueous hydrogen peroxide solution by heating.

26. The process as claimed in claim 25, comprising heating the aqueous hydrogen peroxide solution using hot gases from the calcination apparatus, hot gas leaving a kiln, gas that is heated electrically or gas that is heated using any heating source.

27. The process as claimed in claim 22, comprising heating the limestone prior to introduction to the calcination apparatus.
